(19) United States
(12) Patent Application Publication
(10) Pub. No.: US 2008/0261001 A1
(43) Pub. Date: Oct. 23, 2008

(54) Mounting Substrate Suitable for Use to Install Surface Mount Components

(76) Inventors: Tetsuya Nakatsuka, Yokohama (JP); Koji Serizawa, Yokohama (JP); Shosaku Ishihara, Yokohama (JP); Toshio Saeki, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/572,030

(22) PCT Filed: Feb. 28, 2005
(86) PCT No.: PCT/JP2005/003277

§ 371 Date: Feb. 8, 2008

(30) Foreign Application Priority Data
Jul. 15, 2004 (JP) 2004-208711

(51) Int. Cl. B32B 3/10

(52) U.S. Cl. 428/198

(57) ABSTRACT

Disclosed is a low thermal resistance surface mount component and a mounting substrate bump-connected therewith, capable of removing a soldered low thermal resistance surface mount component from a circuit board without harming the performance of the circuit board or the performance of the low thermal resistance surface mount component. The solder bumps 3 in an area approaching the periphery 2 of the low thermal resistance surface mount component 1 are composed of a solder of a melting point lower than that of the solder bumps 3 in an area approaching the center. The low thermal resistance surface mount component 1 on the circuit board can be removed by partial heating and by melting the solder bumps. However, when the component is partially heated in this manner, the heating temperature declines approaching the periphery compared to that of the center of the low thermal resistance surface mount component 1. Therefore, the solder bump composed of the solder of the low melting point is used in the area approaching the periphery so that the solder bump can be melted even at such a lower heating temperature. As such, the solder bump of the entire surface of the low thermal resistance surface mount component 1 is melted.

### CLAIM OF PRIORITY

The present application claims priority from Japanese Patent Application NO. JP 2004-208711 filed on Jul. 15, 2004, the entire contents of which are hereby incorporated by reference into this application.

### FIELD OF THE INVENTION

The present invention relates to a low thermal resistance surface mount component mixedly mounted on a circuit board using a Pb (lead) free solder alloy the toxicity of which is minor, and a mounting substrate bump-connected therewith.

### BACKGROUND OF THE INVENTION

A Pb free solder alloy can be applied to connect an electronic device to a circuit board of an organic substrate and the like, and is used as a substitution of Sn-37Pb (Unit: Mass %) which is used for soldering at a temperature of approximately 220° C.

A conventional method of soldering a device to a circuit board such as an organic substrate of electric appliances comprises a reflow-soldering process in which hot air is blown against the circuit board, and a solder bump printed on electrodes is molten, to thereby solder (bump-connect) a surface mount component; and a flow-soldering process in which a molten solder jet is contacted with a circuit board and therefore, some surface mount components such as an insertion mounting component, a chip component and so on may be soldered. This soldering method is called a mixed mounting method.

It has been requested, however, to use a Pb free solder alloy the toxicity of which is minor for both the soldering paste used in the reflow-soldering process and the molten solder jet used in the flow-soldering process.

There are prior arts related to this mounting method using Pb free solder. For the Pb free solder, Sn—Ag—Bi system solder or Sn—Ag—Bi—Cu system solder alloy has been known (For example, see Patent Literature 1 for reference).

In addition, another prior art disclosed a method by which an electronic component is surface connected and mounted on surface A of a board by a reflow-soldering process, and then a lead of the electronic component inserted from the surface A side is flow-soldered on surface B of the board, the solder used for the reflow-soldering process in the surface A side being a Pb free solder with the composition of Sn (1.5 to 3.5 wt %), Ag (0.2 to 0.8 wt %), Cu (0 to 4 wt %), In (0 to 2 wt %), and Bi, and the solder used for the flow-soldering process in the surface B being a Pb free solder with the composition of Sn (0 to 3.5 wt %), Ag (0.2 to 0.8 wt %), and Cu. (For example, see Patent Literature 2 for reference).

One of the most frequently used Pb free solders is Sn-3Ag-0.5Cu solder which has a high reliability (−55° C.-125° C., at the temperature cycle test under 1 cycle/h). However, if all the solder bumps of the low thermal resistance surface mount component are bump-connected by using the Sn-3Ag-0.5Cu solder, it was customary to melt even the bumps approaching the center of a component which is difficult to get heated by hot air due to the structural characteristics of a joint during heating the entire substrate as part of the reflow-soldering process. But this often causes the temperature of a package unit of the surface mount component to exceed the heat resistant temperature of the package unit.

To address the above problems, there has been disclosed a solder bump for soldering an electronic component on a substrate. In detail, a high melting point solder bump (melting point: 220° C.) composed of Sn-(2 to 5 wt %)Ag-(0 to 1 wt %)Bi is formed in the corner of the electronic component, while a low melting point solder bump (melting point: 200° C.) composed of Sn-(2 to 5 wt %)Ag-(0 to 1 wt %)Cu-(5 to 15 wt %)Bi is formed on the inside of the electronic component. According to this technique, when the substrate was heated to a predetermined reflow temperature that is lower than the heat resistant temperature of the electronic component (e.g., 230° C.) and higher than the melting point of the high melting point solder (approximately 220° C.) and soldered (bump connected), the solder bumps were immediately molten on the inside of an electronic component even with poor heat transfer conditions (For example, see Patent Literature 3 for reference).
[Patent Literature 1] Japanese Laid-Open No. 10-166178
[Patent Literature 2] Japanese Laid-Open No. 2001-168519
[Patent Literature 3] Japanese Laid-Open No. 2002-141652

Meanwhile, many manufacturers now remove the low thermal resistance surface mount component from its bump-connected circuit board, and recycle the circuit board or the surface mount component. In order to remove the surface mount component from the circuit board, peripheral portions of the surface mount component of the circuit board are subjected to localized (or partial) heating.

However, as aforementioned, since the most frequently used Pb free Sn-3Ag-0.5Cu solder has a very high joint reliability (−55° C.-125° C., at the temperature cycle test under 1 cycle/h), solder bumps for use in bump-connecting low thermal resistance surface mount components to the circuit board are typically made of the high melting point Sn-3Ag-0.5Cu solder. As such, if localized heating is performed on the peripheral portions of a target surface mount component to be removed from the circuit board and if the solder bumps approaching the periphery being relatively difficult to get heated are also melted, the temperature of a package unit of the surface mount component consequently increases higher than the heat resistant temperature of the package unit, deteriorating or destroying the performance of the surface mount component.

The present invention has been archived under these circumstances, and an object of the present invention is to provide a low thermal resistance surface mount component and a mounting substrate bump-connected therewith, capable of removing a soldered low thermal resistance surface mount component from a circuit board without harming the performance of the circuit board or the performance of the low thermal resistance surface mount component.

### SUMMARY OF THE INVENTION

In accordance with the present invention, there is provided a low thermal resistance surface mount component bump-connected to a circuit board, wherein the bump-connection is done by using a solder bump of which melting point is not higher than the heat resistant temperature of a low thermal resistance surface mount component and is lower approaching the periphery than approaching the center on a bump formation side of the low thermal resistance surface mount component.

Another aspect of the present invention provides a mounting substrate comprised of a circuit board bump-connected with a low thermal resistance surface mounting substrate, wherein a solder bump for the bump-connection is made of a solder having a melting point not higher than the heat resistant temperature of a low thermal resistance surface mount component, and a solder bump positioned approaching the center on a solder bump formation side of the low thermal resistance surface mount component has a lower melting point than a solder bump positioned approaching the periphery thereof.

In addition, a soldering paste is applied to the circuit board, and the low thermal resistance surface mounting substrate is bump-connected to the circuit board by heat fusion of the soldering paste and the solder bumps.

Preferably, the solder bumps and the soldering paste are made up of a solder alloy of Sn—Ag—Cu—In system, Sn—Ag—Bi system, Sn—Ag—Bi—Cu system, Sn—Ag—Cu—In—Bi system, Sn—Zn system, or Sn—Zn—Bi system.

Preferably, the solder bumps and the soldering paste is made up of a solder alloy of Sn—Ag—Cu—In system containing 0 to 9 mass % of In.

Preferably, the solder bump and the soldering paste approaching the periphery on the solder bump formation side of the low thermal resistance surface mounting substrate is made up of a solder alloy of Sn—Ag—Cu—In system containing 7 to 9 mass % of In.

### BRIEF DESCRIPTION OF THE DRAWINGS

FIG. 1A and FIG. 1B are front views of different embodiments of a low thermal resistance surface mount component according to the present invention;

FIG. 2 shows main parts of a component removal equipment for removing the low thermal resistance component shown in FIGS. 1A and 1B from a circuit board;

FIG. 3 is an exploded perspective view of the structure of an installation base in the equipment shown in FIG. 2;

FIG. 4 illustrates the structure of a front end portion of a partial heating nozzle for use in the equipment shown in FIG. 2;

FIG. 5A and FIG. 5B are drawings for an explanation of approaching the periphery and approaching the center in the low thermal resistance surface mount component shown in FIG. 1A and FIG. 1B;

FIG. 6 is a table showing the results of a temperature cycle test on a mounting substrate at a temperature range of −55° C. to 125° C. when a low thermal resistance surface mount component was removed from a circuit board by using the equipment shown in FIG. 2;

FIG. 7A and FIG. 7B are front views of different embodiments of a low thermal resistance surface mount component being soldered in a reflow-soldering process; and

FIG. 8 is a table showing the results of a temperature cycle test on a mounting substrate at a temperature range of −55° C. to 125° C., in which the mounting substrate is obtained by reflow soldering the low thermal resistance surface mount component illustrated in FIG. 7A and FIG. 7B onto a circuit board.

In the above Figures, reference numeral 1 denotes a low thermal resistance surface mount component, 1a denotes a package, 2 denotes a corner portion, 2a denotes a periphery approach, 2b denotes a central approach, 3 denotes a solder bump, 4 denotes a circuit board, 5 denotes a component removal equipment, 6 denotes an installation base, 6a denotes an opening portion, 6b denotes infrared ray lamps, 6c denotes fixing metals, 6d denotes supports, 6e denotes fixing metals, 6f denotes support pins, 7 denotes a partial heating nozzle, 7a denotes a diffuser, 7b denotes an attraction nozzle, 7c denotes an adhesive disk, 7d denotes an attraction opening, and 8 denotes a boundary.

### DETAILED DESCRIPTION OF THE PREFERRED EMBODIMENTS

According to the present invention, solder bumps covering over the entire surface of a low thermal resistance surface mount component melt evenly even if the heating temperature approaching the periphery is lower than the heating temperature approaching the center.

Hereinafter, preferred embodiments of the present invention will be set forth in detail with reference to the accompanying drawings so that those skilled in the art can easily carry out the invention.

FIG. 1A is a plan view of an essential portion of a low thermal resistance surface mount component according to the present invention. In FIG. 1A, reference numeral 1 denotes a low thermal resistance surface mount component which is a surface mount component including a low thermal resistance component of this embodiment, reference numeral 1a denotes a package, reference numeral 2 denotes a corner portion, and reference numeral 3 denotes a solder bump.

FIG. 1A illustrates one embodiment of a package 1a as a low thermal resistance surface mount component 1 mounted (bump-connected) onto a circuit board (not shown), which includes a low thermal resistance component. In this embodiment, ball-shaped solder bumps 3 are installed at the peripheral portion of a package surface 1a (hereinafter, the side where the solder bumps 3 are installed is referred to as a bump formation side).

As such, the solder bumps 3 installed at the peripheral portion are called peripheral bumps. A kind of the package as a low thermal resistance surface mount component is a BGA (Ball Grid Array), which is a package with one face covered with pins being solder bumped. In particular, a BGA in which solder bumps 3 are installed at the peripheral portion on the bump formation side is called a peripheral bump array type BGA.

FIG. 1B illustrates another embodiment of the package 1a as the low thermal resistance surface mount component. In this embodiment, ball-shaped solder bumps 3 are placed over the entire bump formation side of the package 1a. The solder bumps 3 in this array are called full grid bumps, and a surface mount component with the alignment of such solder bumps 3 is called a full grip mold. Therefore, a BGA mounted with the full grid bumps 3 is called a full grid mold BGA.

In this embodiment, solder bumps 3 approaching the periphery on the bump formation side of the package 1a as shown in FIG. 1A or FIG. 1B are formed of solders of lower melting point than solder bumps 3 at other positions. Here, the ‘approaching the peripheral’ is represented as a corner portion 2. As such, when locally heating a part of the low thermal resistance surface mount component 1 on the circuit board in order to remove the low thermal resistance surface mount component 1 from a mounting substrate (not shown) on which a circuit board bump-connected with the low thermal resistance surface mount component 1 is mounted, to thereby recycle the circuit board, as will be described later, it is now easy to melt the solder bumps 3 placed near the periphery, the location being hard to get heated, of the low thermal resistance surface mount component 1.

The following will explain a solder alloy forming the solder bump 3.

In a reflow-soldering process in which the low thermal resistance surface mount component 1 is soldered (bump-connected) onto the circuit board with a soldering paste, the Sn—Ag—Cu—In system solder (liquidus-lie temperature: about 210° C.) is widely used in many cases because it has a lower melting point than the conventional Sn-3Ag-0.5Cu composition (liquidus-line temperature: 220° C.) and exhibits a good joint reliability which is not substantially lower than that of the Sn-3Ag-0.5Cu.

Other examples of the low melting point solder besides the Sn-3Ag-0.5Cu include Sn—Ag—Bi system, Sn—Ag—Bi—Cu system, Sn—Ag—Cu—In—Bi system, Sn—Zn system, and Sn—Zn—Bi system.

Meanwhile, using a solder high in Bi content may create a low-melt point eutectic phase by Bi in the solder and Pb used in plating, provided that the plating process (the pre-plating process to be specific) has been performed on electrodes (component electrodes) of the mounting component of interest to enhance wettability of the solder, and cause component segregation due to the influence of heat during an additional soldering process after the reflow-soldering process having been performed on insertion mounting components and the like, eventually leading to breakage of a joint. Preventing the breakage of the joint and lowering the soldering temperature for the purpose of protecting the low thermal resistance surface mount component inevitably impose a limitation on Bi content or the variety of possible circuit boards capable of incorporating a Bi-containing solder.

Moreover, a solder high in Zn content does not provide good wettability onto an electrode. Assuring sufficient wettability and lowering the soldering temperature at the same time also place a great limitation on Zn content or the variety of possible circuit boards capable of incorporating a Zn-containing solder.

With all of the above considered, it is desirable to use a soldering paste of Sn—Ag—Cu—In system when a low temperature soldering process is required for the purpose of protecting low thermal resistance surface mount components as they are to be soldered onto a circuit board.

However, even though the low melting point Sn—Ag—Cu—In system solder is used as a soldering paste, if a surface mount component is bump-connected to a circuit board and solder bumps installed on the surface mount component are formed of a high melting point solder such as Sn-3Ag-0.5Cu (liquidus-line temperature: 220° C.), the soldering paste entered in molten phase during the reflow-soldering process fuses with the solder bumps in their joints. Consequently, the melting point of the soldering paste increases close to the melting point of the Sn-3Ag-0.5Cu used for the solder bumps, and defects in the melting process occur. In order to prevent this, it is desirable to use the Sn—Ag—Cu—In system solder not only for the soldering paste but also for the solder bump on the surface mount component side.

Further, if the Sn—Ag—Cu—In soldering paste contains more than 7 to 9 mass % of In, In itself contributes to the low-melt point eutectic phase. As such, to protect low thermal resistance surface mount components, it is necessary to increase the In content in the soldering paste as much as possible so that the soldering temperature may be lowered as desired. Because of this, In content in the reflowing solder for use with the low thermal resistant surface mount component is preferably in range of 7 to 9 mass %.

Accordingly, by making the solder bumps on the surface mount component side have the same composition as the soldering paste, the melting point by heat fusion of the soldering paste and the solder bump can be increased. In other words, the melting defect of the soldering paste can be suppressed. However, the In content in the solder bumps on the surface mount component side should not exceed the In content in the soldering paste, so as to prevent deterioration in the joint reliability. Thus, an adequate content of In needs to be set between 0 and 9 mass %.

To be short, if the solder bumps on the surface mount component side are made up of the Sn—Ag—Cu—In system solder same as the soldering paste and if the solder bumps approaching the peripheral on the bump formation side of the surface mount component contain 7 to 9 mass % of In, although they are difficult to get heated, it becomes easier to melt those solder bumps approaching the periphery of the surface mount component especially when localized (partial) heating is performed on a part of the surface mount component soldered onto the mounting substrate, so as to remove the surface mount component from the mounting substrate to thereby recycle the circuit board.

Next, removal of the low thermal resistance surface mount component 1 depicted in FIG. 1A or FIG. 1B is explained.

As one embodiment of the mounting substrate of the present invention, it is assumed that a peripheral bump array type BGA 1 (heat resistant temperature: 220° C., component size: 30 mm×30 mm, bump pitch: 1.27 mm, and total number of bumps: 256), which is the low thermal resistance surface mount component as shown in FIG. 1A, is soldered (bump-connected) onto a circuit board (not shown) by solder bumps 3 and soldering paste (not shown, thickness of the soldering paste: 0.15 mm).

As described above, the solder bumps or the soldering paste applied to the mounting substrate is formed of the Sn—Ag—Cu—In system solder, in which the In content in both the soldering paste and the solder bumps is in range of 0 to 9 mass %. Although the In content in the solder bumps is lower than the In content in the soldering paste, the In content in the solder bumps 3 in an area approaching the periphery (i.e., the corner portion 2 in FIG. 1A) on the bump formation side of the peripheral bump array type BGA1 is in range of 7 to 9 mass %, which resultantly lowers the melting point of the solder bumps 3 compared with the melting point of solder bumps in other places.

In such peripheral bump array type BGA1 on the mounting substrate before the circuit board is separated, the solder bumps on the peripheral bump array type BGA1 side and the solder paste on the circuit board side are not completely fused, but the soldering paste connected to the solder bumps is in perfect molten phase.

Moreover, the peripheral bump array type BGA1 is connected to the circuit board by a reflow soldering device. In the reflow soldering device, heating zones (heater pairs existing above and below the substrate carrier conveyor) use infrared rays and hot air in combination, the number of the heating zones is set to 10, and the oxygen concentration is set to 100 ppm using nitrogen to inert the atmosphere during soldering.

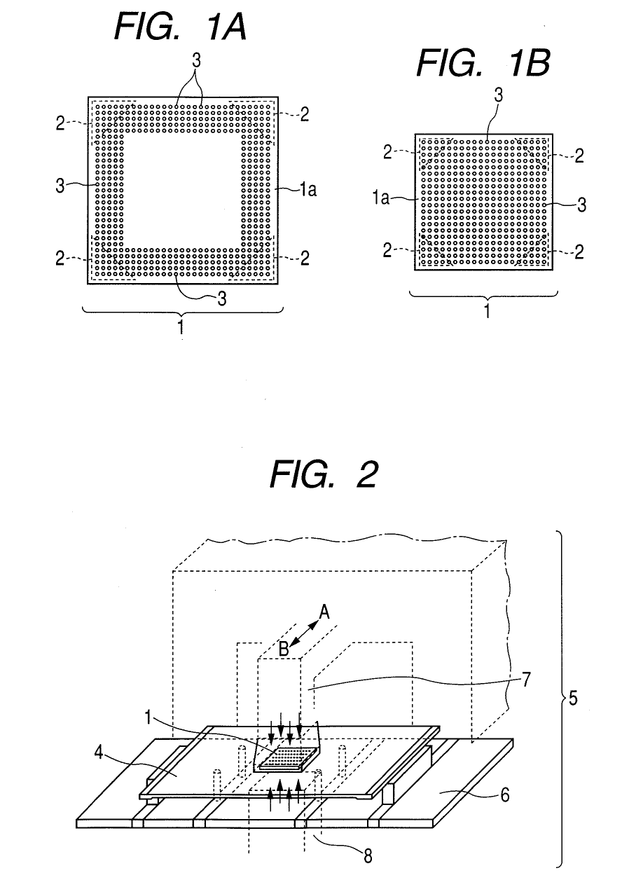

FIG. 2 is a schematic view showing main parts of a component removal equipment for removing the low thermal resistance component from a circuit board. In FIG. 2, reference numeral 4 denotes a circuit board, reference numeral 5 denotes a component removal equipment, reference numeral 6 denotes an installation base, reference numeral 7 denotes a partial heating nozzle, and reference numeral 8 denotes a heating nozzle.

As shown in the drawing, the mounting substrate formed of the peripheral bump array type BGA1 bump-connected to the circuit board 4 is placed on the installation base 4a, and the peripheral bump array type BGA1 is installed between the partial heating nozzle 7 and the heating nozzle 8 arranged on vertically opposite sides. And, the circumference of the peripheral bump array type BGA1 on the circuit board 4 is heated by an infrared ray lamp (not shown) placed on the installation base 6 below, and hot air jetted from the partial heating nozzle 7 and the heating nozzle 8 heat the peripheral bump array type BGA1 in upward/downward directions.

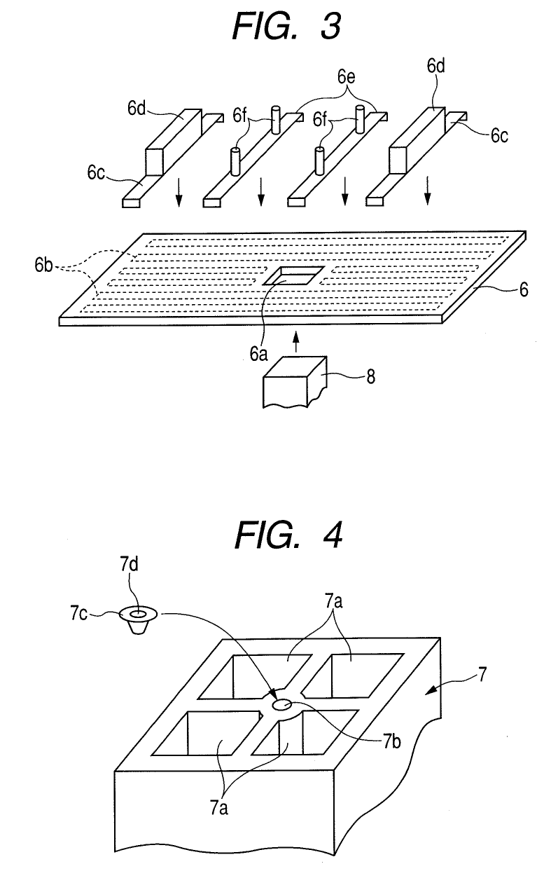

FIG. 3 is an exploded perspective view of the structure of the installation base 6 in the component removal equipment 5 shown in FIG. 2. In FIG. 3, reference numeral 6a denotes an opening portion, reference numeral 6b denotes infrared ray lamps, reference numerals 6c and 6e denote fixing metals, reference numeral 6d denotes supports, and reference numeral 6f denotes support pins. Like elements shown in FIG. 2 are designated by the same reference numerals.

In the same drawing, the installation base 6 has a horizontally oblong rectangle shape, and its central portion has a through hole 6a penetrating the installation base 6 in a downward direction. The cross section of the through hole 6a is either a square or a circular shape. The front end portion of the heating nozzle 8 is inserted into this through hole 6a. Besides the through hole 6a, there are a predetermined number of infrared ray lamps 6b are installed in the installation base 6. These infrared ray lamps 6b may be exposed upwardly or their upper surfaces transmitting infrared rays of the installation base 6 may be coated.

The supports 6d are fixed onto the fixing metals 6c, and attached to the installation base 6 by means of the fixing metals 6c in such a manner that the longitudinal direction of the support 6d coincides with the lateral direction of the installation base 6. There are two supports 6d, each having the fixing metal 6c. These supports 6d are mounted on the installation base 6 so as to be bilaterally symmetric about the through hole 6a (see FIG. 2 for reference). Similarly, two support pins 6f are fixed onto one fixing metal 6e and then attached to the installation base 6 by means of the fixing metal 6e in such a manner that the longitudinal direction of those two support pins 6f coincides with the lateral direction of the installation base 6. That is, two support pins 6f are fixed onto the same fixing metal 6e, and then attached to the installation base 6 in its lateral direction. There are two fixing metals 6e to which the support pins 6f are attached, and the support pins 6f are mounted on the installation base 6 so as to be bilaterally symmetric about the through hole 6a between the two supports 6d (see FIG. 2 for reference). Here, the supports 6d are provided with an adhesive means.

The circuit board 4 shown in FIG. 2 is supported by two supports 6d and four support pins 6f, by placing its peripheral bump array type BGA1 to be on opposite side of the through hole 6a. At this time, the circuit board 4 is fixed by the adhesive means applied to the supports 6d.

With the circuit board 4 being supported, a portion of the circuit board 4 onto which the peripheral bump array type BGA1 is soldered is subjected to a hot air flow jetted from the heating nozzle 8 through the through hole 6a, being heated from the bottom of the circuit board 4. Also, in the circuit board 4 supported by the supports 6d and the support pins 6f, the circumference of an area corresponding to the through hole 6a is heated from the bottom by infrared rays emitted from the infrared lamps 6b.

FIG. 4 is a perspective view illustrating the structure of the front end portion of the partial heating nozzle 7 in FIG. 2. In FIG. 4, reference numeral 7a denotes a diffuser, reference numeral 7b denotes an attraction nozzle, reference numeral 7c denotes an adhesive disk, and reference numeral 7e denotes an attraction opening.

As shown in the drawing, an attraction nozzle 7b is formed at the center of the front end portion of the partial heating nozzle 7, and a plurality of diffusers 7a (e.g., four in this embodiment) for diffusing hot air are installed at its circumference. The adhesive disk 7c is made of rubber and the like, and is inserted into the attraction nozzle 7b. The center of the adhesive disk 7c is the attraction opening 7d. Thus, when the adhesive disk 7c is inserted into the attraction nozzle 7b, the attraction nozzle 7b can communicate with outside from the attraction opening 7d. The air is intaken from the attraction nozzle 7b by a vacuum pump (not shown).

Returning to FIG. 2, the partial heating nozzle 7 is movable in the direction the arrows A and B are pointing (in the lateral direction of the installation base 6). In particular, when the circuit board 4 is installed on the installation base 6, it moves in the direction the arrow A is pointing and is placed away from the installation base 6. With this condition, the circuit board 4 bump-connected with the peripheral bump array type BGA1 is installed in a manner that the peripheral bump array type BGA1 is disposed to face the through hole 6a (FIG. 3) formed in the installation base 6, to thereby be supported by the supports 6d and the support pins 6f (FIG. 3). Further, the circuit board 4 is adhesively fixed to the supports 6d with an application of the attraction means of the supports 6d.

And, the partial heating nozzle 7 moves in the direction the arrow B is pointing that is reversely from the direction the arrow A is pointing, faces the peripheral bump array type BGA1 on the circuit board 4, and is placed near the peripheral bump array type BGA1. Then, hot air from the diffusers 7a (FIG. 4) of the partial heating nozzle 7 is jetted at the top of the peripheral bump array type BGA1 and, hot air from the heating nozzle 8 is jetted at the bottom of the circuit board 4. In this way, the solder used for fixing the peripheral bump array type BGA1 onto the circuit board 4 is heated and melted. When the peripheral bump array type BGA1 becomes removable from the circuit board 4 after being heated for a predetermined amount of time, it is subjected to an attractive force induced by the intaken air through the attraction nozzle 7b (FIG. 4) of the partial heating nozzle 7. In result, the peripheral bump array type BGA1 is separated from the circuit board 4 and then adhered to the adhesive disk 7c that is attached to the attraction nozzle 7b.

As such, when the peripheral bump array type BGA1 is adhered onto the adhesive disk 7c, the heating process by the partial heating nozzle 7 and the heating nozzle 8 stops and the partial heating nozzle 7 moves in the direction the arrow A is pointing, thereby removing the peripheral bump array type BGA1 from the mounting substrate.

The circuit board 4, besides the peripheral bump array type BGA1, is also bump-connected with a 56 lead TSOP (Thin Small Outline Package) having a lead installed on a longer side of the package having the most strict connection conditions onto the circuit board. Therefore, a Sn-3Ag-0.5Cu-7In solder is used for the soldering paste and the In content therein is 7 mass % which is known as the maximum amount for the TSOP to assure a 1000 cycle life of temperature cycling from −55° C. to 125° C.

However, in case of heating the peripheral bump array type BGA1 portion through the partial heating nozzle 7 and the heating nozzle 8 in order to remove the peripheral bump array type BGA1 from the circuit board 4 by using the component removal equipment 5, the area facing the center of the front end surface where hot air from the partial heating nozzle 7 is jetted (i.e., the center of the plane of the peripheral bump array type BGA1) has the highest temperature, and the temperature declines approaching the periphery of the peripheral bump array type BGA1. Because of this, if high melting point solder bumps are used near the periphery and if the temperature near the periphery gets higher than the melting point of the solder bumps, the temperature at the center portion of the peripheral bump array type BGA1 exceeds the heat resistant temperature of the peripheral bump array type BGA1, thereby adversely affecting the performance of the peripheral bump array type BGA1 or even destroying it. Therefore, in this embodiment, as explained in FIGS. 1A and 1B before, solder bumps composed of the Sn—Ag—Cu—In solder of low melting point are formed at the periphery of the peripheral bump array type BGA1.

For the Sn—Ag—Cu—In system solder, the higher In content it has, the lower the melting point becomes. Thus, as described above, within the range that does not exceed the In content in the soldering paste composed of the same solder, the In content is increased in the Sn—Ag—Cu—In system solder composing the solder bumps formed in an area approaching the periphery on the bump formation side of the peripheral bump array type BGA1. However, if the In content is greater than 7 to 9 mass %, In itself contributes to the low-melt point eutectic phase. As such, the In content desirably falls within the range of 0 to 9 mass % to yield a predetermined melting point (to be described).

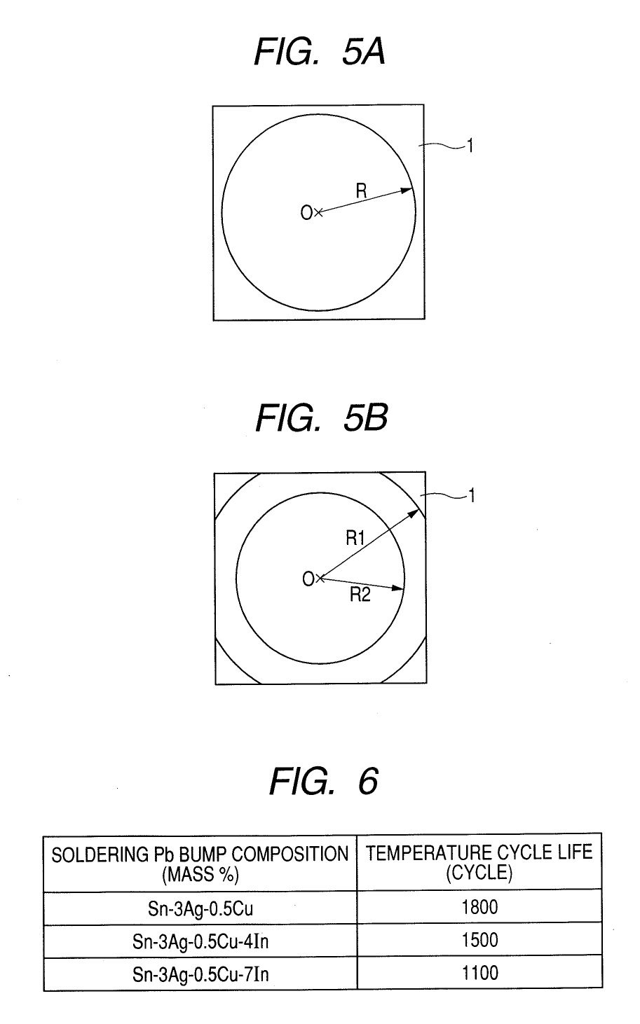

Here, as shown in FIG. 5A, the periphery where the solder bumps of lower melting point than the solder bumps used at the central portion are formed on the peripheral bump array type BGA1 corresponds to an area outside the circumference of a circle having a radius R from its center O of the peripheral bump array type BGA1 as an origin. The radius R is determined, for example, by temperature distribution at the circuit board 4 when it is heated by the partial heating nozzle 7, the heating nozzle 8 and the infrared ray lamps 6b in the component removal equipment 5 shown in FIGS. 2-4.

Moreover, when the inner area of the circumference of the radius R (i.e., the area approaching the center) is heated at a temperature higher than the melting point of the solder bumps formed therein and a temperature lower than the heat resistant temperature of the peripheral bump array type BGA1 (220° C. in this case), although the outer area of the circumference of the radius R on the bump formation side of the peripheral bump array type BGA1 (i.e., the area approaching the periphery) is heated at a temperature lower than the heating temperature in the area approaching the center, solder bumps 3 composed of the Sn—Ag—Cu—In system solder of melting point lower than this heating temperature are formed in the area approaching the periphery. This area approaching the periphery is indicated as the corner portion 2 in the peripheral bump array type BGA1 shown in FIG. 1A.

As such, in case that the area approaching the periphery is set and that the periphery approaching area is formed of the solder bumps 3 of lower melting point than the solder bumps 3 formed in an area approaching the center, in order to remove the periphery bump array type BGA1 from the circuit board 4 by using the component removal equipment 5 shown in FIGS. 2-4, the mounting substrate which is formed of the circuit board 4 and the peripheral bump array type BGA1 bump-connected therewith is installed at the installation base 6 to make the center O on the bump formation side of the peripheral bump array type BGA1 face the center of the partial heating nozzle 7 (i.e., the attraction nozzle 7b). Under this condition, when the area approaching the center on the bump formation side of the peripheral bump array type BGA1 is heated at a temperature that is lower than the heat resistant temperature of the peripheral bump array type BGA1 and higher than the melting point of the solder bumps 3 near the center, the area approaching the periphery on the bump formation side gets also heated at a temperature higher than the melting point of the solder bumps 3 near the periphery. In other words, as the solder bumps 3 over the entire bump formation side of the peripheral bump array type BGA1 are melted, it becomes easier to remove the peripheral bump array type BGA1 from the circuit board 4.

In addition, as illustrated in FIG. 5B, the peripheral bump array type BGA1 is divided into three areas with different radii R1 and R2 (R1>R2) with respect to the center O, and solder bumps 3 of low melting point are formed in the area approaching the periphery. That is, provided that the melting point of the solder bumps in the inner area of the circumference of the circle of radius R2 is Ta, the melting point of the solder bumps in an area between the circumferences of the circles of radii R1 and R2 is Tb, and the melting point of the solder bumps in an outer area of the circumference of the circle of radius R1 is Tc, Ta>Tb>Tc. Needless to say, the number of areas may be divided into more than three, and the melting point of the solder bumps may be set to be decreased when approaching the periphery. Moreover, instead of dividing the peripheral bump array type BGA1 into areas, it is also possible to set the melting point of the solder bumps 3 to gradually decline as it goes to an area away from the center of the peripheral bump array type BGA1.

Therefore, in order to remove the peripheral bump array type BGA1 bump-connected to the circuit board 4 with the solder bumps 3 of the designated melting point by using the component removal equipment 5 shown in FIGS. 2-4, hot air is jetted from the partial heating nozzle 7 and the heating nozzle 8 onto the peripheral bump array type BGA1 and at the same time the adhesive disk 7c (FIG. 4) attracts the peripheral bump array type BGA1. As such, when the solder bumps 3 of the peripheral bump array type BGA1 melt, the peripheral bump array type BGA1 gets separated from the circuit board 4 through the adhesion of the adhesive disk 7c.

Then, the mounting substrate formed of the circuit board 4 and the peripheral bump array type BGA1 soldered (bump-connected) therewith was attached to the component removal equipment 5 shown in FIGS. 2-4, and a thermocouple was installed to measure a temperature at the central portion and a temperature at the corner portion of the peripheral bump array type BGA1. In addition, the peripheral bump array type BGA1 was heated with the partial heating nozzle 7 and the heating nozzle 8, and the circuit board 4 was heated with the infrared ray lamps 6b. Based on the temperature measurement results obtained from the thermocouple, the peak temperature at the central portion on the bump formation side of the peripheral bump array type BGA1 was adjusted to 220° C. the heat resistant temperature of the peripheral bump array type BGA1. Later, the inventors discovered that the peak temperature at the corner portion on the bump formation side of the peripheral bump array type BGA1 was 205° C.

Further, when solder bumps for the peripheral bump array type BGA1 were composed of the Sn-3Ag-0.5Cu solder, the melting defects of the soldering paste were observed in 7 points of the solder joints on the corner portion. On the contrary, when solder bumps in an area approaching the periphery on the bump formation side of the peripheral bump array type BGA1 were composed of the Sn-3Ag-0.5Cu-(4 to 7 mass %)In solder, the melting defects of the soldering paste on the corner portion were not detected and the peripheral bump array type BGA1 could easily be removed from the circuit board 4. In addition, when the temperature cycle test was conducted on the solder joints on the corner portion of the peripheral bump array type BGA1 at −55 to 125° C., each bump solder containing 0 mass %, 4 mass %, and 7 mass % of In, at least the average cycle life (1000 cycles) was obtained for each sample as shown in the table of FIG. 6.

Accordingly, for the mounting substrate formed of the circuit board 4 and the peripheral bump array type BGA1 bump-connected therewith, the solder bumps in an area approaching the center and in an area approaching the periphery on the bump formation side of the peripheral bump array type BGA1 were composed of solders of melting point depending on the heating temperature at the area approaching the periphery (that is, the In content) which is resulted from heating the solder bumps in the area approaching the center. In doing so, the solder bumps covered over the entire peripheral bump array type BGA1 were melted evenly, and the peripheral bump array type BGA1 was easily separated from the circuit board 4. Especially, the peripheral bump array type BGA1 could easily be removed from the circuit board 4 without harming the performance of the circuit board 4 or the performance of the peripheral bump array type BGA1.

So far, the description has been focused mainly on the peripheral bump array type BGA1 depicted in FIG. 1A. However, the same results are obtained from the full grid mold BGA (for example, heat resistant temperature: 220° C., component size: 23 mm×23 mm, bump pitch: 1.0 mm, total number of bumps: 484, and the BGA is bump-connected to the circuit board by the soldering paste of 0.15 mm in thickness) in which solder bumps are installed over the entire surface of the BGA.

Next, the reflow-soldering process for reflow soldering the low thermal resistant surface mount component onto the circuit board is explained.

As mentioned before, the typically used solder bumps for a low thermal resistance surface mount component subjected to the reflow-soldering process are composed of a Sn-3Ag-0.5Cu solder because this most frequently used Pb free Sn-3Ag-0.5Cu solder has a very high joint reliability (−55° C.-125° C., at the temperature cycle test under 1 cycle/h). However, if hot air is jetted onto the entire circuit board to reflow solder a low thermal resistance surface mount component onto the circuit board by using the above solder bumps, because of the structural characteristics of joints between the low thermal resistance surface mount component and the circuit board, the hot air hardly approaches the center of a low thermal resistance surface mount component between the low thermal resistance surface mount component and the circuit board. Nevertheless, if the solder bumps in an area near the center are melted, the temperature of the package unit in the low thermal resistance surface mount component increases above the heat resistant temperature thereof, adversely affecting the performance of the package unit.

Therefore, in the low thermal resistance surface mount component of the present invention the solder bumps formed in an area approaching the center are composed of a solder having a lower melting point than that of the solder bumps in an area approaching the periphery. This in turn makes it easier to heat the solder bumps in an area approaching the center of the low thermal resistance surface mount component that used to be difficult to get heated during heating the entire circuit board to solder the low thermal resistance surface mount component onto the circuit board.

The following will now explain the composition of the above-described solder.

In the reflow-soldering process in which a low thermal resistance surface mounting having a low thermal resistance component to be bump connected is soldered onto a circuit board with a soldering paste, the Sn—Ag—Cu—In system solder (liquidus-lie temperature: about 210° C.) is widely used in many cases because it has a lower melting point than the conventional Sn-3Ag-0.5Cu composition (liquidus-line temperature: 220° C.) and exhibits a good joint reliability which is not substantially lower than that of the Sn-3Ag-0.5Cu.

Other examples of the low melting point solder besides the Sn—Ag—Cu—In system include Sn—Ag—Bi system, Sn—Ag—Bi—Cu system, Sn—Ag—Cu—In—Bi system, Sn—Zn system, and Sn—Zn—Bi system.

Meanwhile, using a solder high in Bi content may create a low-melt point eutectic phase by Bi in the solder and Pb used in plating, provided that the plating process (the pre-plating process to be specific) has been performed on electrodes of the surface mount component of interest to enhance wettability of the solder, and cause component segregation due to the influence of heat during an additional soldering process after the reflow-soldering process having been performed on insertion mounting components and the like, eventually leading to breakage of a joint. Preventing the breakage of the joint and lowering the soldering temperature for the purpose of protecting the low thermal resistance surface mount component inevitably impose a limitation on Bi content or the variety of possible circuit boards capable of incorporating a Bi-containing solder.

Moreover, if a solder high in Zn content is used, wettability of the surface mount component onto an electrode is usually poor. Assuring sufficient wettability and lowering the soldering temperature at the same time also place a great limitation on Zn content or the variety of possible circuit boards capable of incorporating a Zn-containing solder.

With all of the above considered, it is desirable to use a soldering paste of Sn—Ag—Cu—In system when a low temperature soldering process is required for the purpose of protecting low thermal resistance surface mount components as they are to be soldered onto a circuit board.

However, even though the low melting point Sn—Ag—Cu—In system solder is used as a soldering paste, if a surface mount component is bump-connected to a circuit board and solder bumps installed on the surface mount component are composed of a high melting point solder such as Sn-3Ag-0.5Cu (liquidus-line temperature: 220° C.), the soldering paste entered in molten phase during the reflow-soldering process fuses with the solder bumps in their joints and therefore, the melting point of the soldering paste increases close to the melting point of the Sn-3Ag-0.5Cu used for the solder bumps,

For the above reason, it is necessary to compose the solder on the fused portion within the original composition of the paste. To this end, it is desirable to use the Sn—Ag—Cu—In system solder for both the soldering paste and the solder bump on the surface mount component side.

Further, if the Sn—Ag—Cu—In soldering paste contains more than 7 to 9 mass % of In, In itself contributes to the low-melt point eutectic phase. As such, to protect low thermal resistance surface mount components, it is necessary to increase the In content in the soldering paste as much as possible so that the soldering temperature may be lowered as desired. Because of this, In content in the reflowing solder for use with the low thermal resistant surface mount component is preferably in range of 7 to 9 mass %.

Accordingly, by making the solder bumps on the low thermal resistance surface mount component side have the same composition as the soldering paste, the melting point by heat fusion of the soldering paste and the solder bump can be increased. In other words, the melting defect of the soldering paste can be suppressed. However, the In content in the solder bumps on the low thermal resistance surface mount component side should not exceed the In content in the soldering paste, so as to prevent deterioration in the joint reliability. An adequate content of In needs to be set between 0 and 9 mass %.

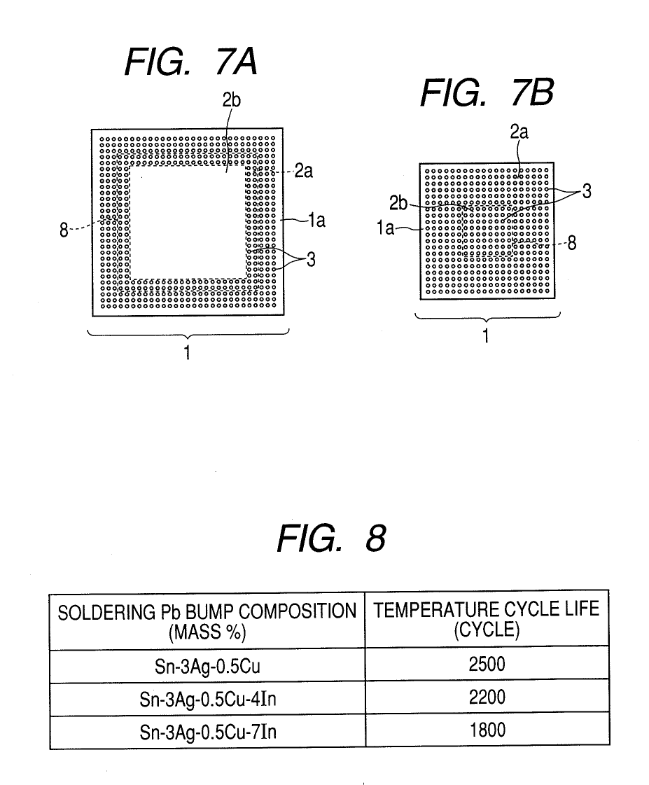

FIG. 7A and FIG. 7B are plan views of different embodiments of a package unit in the low thermal resistance surface mount component. In particular, FIG. 7A illustrates a peripheral bump array type BGA, and FIG. 7B illustrates a full grid mold BGA, respectively. Like elements shown in FIGS. 1A and 1B are designated by the same reference numerals. In the drawing, reference numeral 2a denotes a periphery approach, reference numeral 2b denotes a central approach, and reference numeral 8 denotes a boundary between the periphery approach 2a and the central approach 2b.

In FIGS. 7A and 7B, with respect to the boundary 8 at a certain distance away from the outer side of the BGA1, the outer side of the boundary corresponds to the peripheral approach 2a, and the inner side of the boundary corresponds to the central approach 2b. The solder bumps 3 in the area of the central approach 2b are composed of a solder of lower melting point than that of the solder bumps 3 in the area of the periphery approach 2a.

The following now explains the solder bump 3. Some of the explanation is taken in repetition from the explanation on the solder bump shown in FIGS. 1A and 1B.

In a reflow-soldering process in which the low thermal resistance surface mount component 1 is soldered (bump-connected) onto the circuit board with a soldering paste, the Sn—Ag—Cu—In system solder (liquidus-lie temperature: about 210° C.) is widely used in many cases because it has a lower melting point than the conventional Sn-3Ag-0.5Cu composition (liquidus-line temperature: 220° C.) and exhibits a good joint reliability which is not substantially lower than that of the Sn-3Ag-0.5Cu.

Other examples of the low melting point solder besides the Sn-3Ag-0.5Cu include Sn—Ag—Bi system, Sn—Ag—Bi—Cu system, Sn—Ag—Cu—In—Bi system, Sn—Zn system, and Sn—Zn—Bi system.

Meanwhile, using a solder high in Bi content may create a low-melt point eutectic phase by Bi in the solder and Pb used in plating, provided that the plating process (the pre-plating process to be specific) has been performed on electrodes (component electrodes) of the mounting component of interest to enhance wettability of the solder, and cause component segregation due to the influence of heat during an additional soldering process after the reflow-soldering process having been performed on insertion mounting components and the like, eventually leading to breakage of a joint. Preventing the breakage of the joint and lowering the soldering temperature for the purpose of protecting the low thermal resistance surface mount component inevitably impose a limitation on Bi content or the variety of possible circuit boards capable of incorporating a Bi-containing solder.

Moreover, a solder high in Zn content does not provide good wettability onto an electrode. Assuring sufficient wettability and lowering the soldering temperature at the same time also place a great limitation on Zn content or the variety of possible circuit boards capable of incorporating a Zn-containing solder.

With all of the above considered, it is desirable to use a soldering paste of Sn—Ag—Cu—In system when a low temperature soldering process is required for the purpose of protecting low thermal resistance surface mount components as they are to be soldered onto a circuit board.

However, even though the low melting point Sn—Ag—Cu—In system solder is used as a soldering paste, if a surface mount component is bump-connected to a circuit board and solder bumps installed on the surface mount component are formed of a high melting point solder such as Sn-3Ag-0.5Cu (liquidus-line temperature: 220° C.), the soldering paste entered in molten phase during the reflow-soldering process fuses with the solder bumps in their joints. Consequently, the melting point of the soldering paste increases close to the melting point of the Sn-3Ag-0.5Cu used for the solder bumps, and defects in the melting process occur. In order to prevent this, it is desirable to use the Sn—Ag—Cu—In system solder not only for the soldering paste but also for the solder bump on the surface mount component side.

Further, if the Sn—Ag—Cu—In soldering paste contains more than 7 to 9 mass % of In, In itself contributes to the low-melt point eutectic phase. As such, to protect low thermal resistance surface mount components, it is necessary to increase the In content in the soldering paste as much as possible so that the soldering temperature may be lowered as desired. Because of this, In content in the reflowing solder for use with the low thermal resistant surface mount component is preferably in range of 7 to 9 mass %.

Accordingly, by making the solder bumps on the surface mount component side have the same soldering composition of the Sn—Ag—Cu—In system as the soldering paste, the melting point by heat fusion of the soldering paste and the solder bump can be increased. In other words, the melting defect of the soldering paste can be suppressed. However, the In content in the solder bumps on the surface mount component side should not exceed the In content in the soldering paste, so as to prevent deterioration in the joint reliability. Thus, an adequate content of In needs to be set between 0 and 9 mass %.

Moreover, by increasing the In content in the solder bumps in the area approaching the center of the surface mount component side relatively to the In content in the solder bumps in the area approaching the periphery (that is, the In content approximates 7 to 9 mass %), a low melting point solder can be formed. When the circuit board is heated to solder (bump connect) the surface mount component thereon, the solder bumps in the area approaching the center of the surface mount component that used to be difficult to get heated could easily be melted, facilitating the fusion between the solder bumps and the soldering paste to thereby provide good bump joint reliability.

Next, an embodiment of the reflow-soldering process is explained.

In this embodiment, the full grid mold BGA (for example, heat resistant temperature: 220° C., component size: 23 mm×23 mm, bump pitch: 1.0 mm, and total number of bumps: 484) illustrated in FIG. 7B is used as a low thermal resistance surface mount component 1. In the reflow-soldering process, such a full grid mold BGA1 is mounted on a circuit board (not shown) printed with a soldering paste (thickness: 0.15 mm), and the reflow-soldering process was performed at a lowest temperature where the solder paste reflow is possible.

In a reflow soldering device, a total of 5 heating zones (heater pairs existing above and below the substrate carrier conveyor) use infrared rays and hot air in combination, and the oxygen concentration is set to 100 ppm using nitrogen to inert the atmosphere during soldering.

Further, the circuit board, besides the full grid mold BGA1, is also bump-connected with a 48 lead TSOP having a lead installed on a longer side of the package having the most strict connection conditions onto the circuit board. Therefore, a Sn-3Ag-0.5Cu-7In solder is used for the soldering paste and the In content therein is 7 mass % which is known as the maximum amount for the TSOP to assure a 1000 cycle life of temperature cycling from −55° C. to 125° C.

In addition, during the reflow-soldering process, the solder joint existing in the central approach 2b (FIG. 7) of the full grid mold BGA1 has the lowest temperature, while the periphery approach 2a (especially, the corner portion in FIG. 7) has the highest temperature that does not necessarily exceed the heat resistant temperature, 220° C., of the full grid mold BGA1.

Accordingly, when soldering the full grid mold BGA1 onto the circuit board, a thermocouple was installed to measure a temperature at the solder joint of the central approach 2b of the full grid mold BGA1 and a temperature at the corner portion of the package unit 1a in the full grid mold BGA1, respectively. It turned out that when the peak temperature at the corner portion of the package unit 1a in the full grid mold BGA1 was adjusted to 220° C., the peak temperature at the solder joint in the central approach 2b of the full grid mold BGA1 was 204° C.

Moreover, when solder bumps 3 for the full grid mold BGA1 thus obtained from the reflow-soldering process were composed of the Sn-3Ag-0.5Cu solder, the melting defects of the soldering paste were observed in 5 points of the solder joints of the central approach 2b in the full grid mold BGA1. On the contrary, when solder bumps were composed of the Sn-3Ag-0.5Cu-(4 to 7 mass %)In solder, the melting defects of the soldering paste on the corner portion were not detected.

In addition, when the temperature cycle test was conducted on the solder joints of the central approach 2b in the full grid mold BGA1 at −55 to 125° C., each bump solder containing 0 mass %, 4 mass %, and 7 mass % of In, at least the average cycle life (1000 cycles) was obtained for each sample as shown in the table of FIG. 8.

Also, the same results described so far are obtained from the peripheral bump array type surface mount components 1 illustrated in FIG. 7A.

In conclusion, according to the present invention, the low thermal resistance surface mount component soldered onto the circuit board can easily be removed from the circuit board without harming the performance of the circuit board or the performance of the low thermal resistance surface mount component. As such, the present invention is excellent in economic efficiency in that the low thermal resistance surface mount component exhibits an improved reliability and the mounting component bump-connected therewith can be recycled, making effective use of resources.

What is claimed is:

1. A low thermal resistance surface mount component bump-connected to a circuit board,
wherein the bump-connection is done by using a solder bump of which melting point is not higher than the heat resistant temperature of a low thermal resistance surface mount component and is lower approaching the periphery than approaching the center on a bump formation side of the low thermal resistance surface mount component.

2. A mounting substrate comprised of a circuit board bump-connected with a low thermal resistance surface mounting substrate,
wherein a solder bump for the bump-connection is composed of a solder having a melting point not higher than the heat resistant temperature of a low thermal resistance surface mount component, and
a solder bump positioned approaching the center on a solder bump formation side of the low thermal resistance surface mount component has a lower melting point than a solder bump positioned approaching the periphery thereof.

3. The mounting substrate according to claim 2,
wherein a soldering paste is applied to the circuit board, and
the low thermal resistance surface mounting substrate is bump-connected to the circuit board by heat fusion of the soldering paste and the solder bumps.

4. The mounting substrate according to claim 3,
wherein the solder bumps and the soldering paste are composed of a solder alloy of Sn—Ag—Cu—In system, Sn—Ag—Bi system, Sn—Ag—Bi—Cu-system, Sn—Ag—Cu—In—Bi system, Sn—Zn system, or Sn—Zn—Bi system.

5. The mounting substrate according to claim 3 or claim 4,
wherein the solder bumps and the soldering paste is made up of a solder alloy of Sn—Ag—Cu—In system containing 0 to 9 mass % of In.

6. The mounting substrate according to claim 5,
wherein the solder bump and the soldering paste approaching the periphery on the solder bump formation side of the low thermal resistance surface mounting substrate is made up of a solder alloy of Sn—Ag—Cu—In system containing 7 to 9 mass % of In.
